(19) United States
(12) Patent Application Publication
(10) Pub. No.: US 2024/0046733 A1
(43) Pub. Date: Feb. 8, 2024

(54) KIOSK-INTEGRATED CIGARETTE VENDING MACHINE

(71) Applicant: UNOS CO. LTD., Gyeonggi-do (KR)

(72) Inventors: Youngwoo SONG, Anyang-si Gyeonggi-do (KR); Youngkwon SONG, Suwon-si Gyeonggi-do (KR)

(21) Appl. No.: 18/249,996

(22) PCT Filed: Mar. 3, 2023
(86) PCT No.: PCT/KR2023/002895

§ 371 Date: Sep. 28, 2023

(30) Foreign Application Priority Data
Mar. 21, 2022 (KR) 10-2022-0034482

(51) Int. Cl. G07F 11/54; G06F 3/0488; G07F 11/00; G07F 7/08

(52) U.S. Cl. CPC G07F 11/54; G06F 3/0488; G07F 11/007; G07F 7/08

(57) ABSTRACT

Provided is a kiosk-integrated cigarette vending machine, which employs an internal loading/unloading unit having a cylindrical loading tray, thereby minimizing the size thereof and thus maximizing the efficiency of use of space compared to a conventional vending machine having a horizontal arrangement structure, which includes a reduced number of modules to be controlled, i.e. a rotary module for rotating the cylindrical loading tray and a push module for pushing a selected one of cigarette packs loaded in the cylindrical loading tray to dispense the same, thereby minimizing the probability of error occurrence and simplifying the maintenance thereof, and which includes size guides formed to be selectively mounted in slots in the cylindrical loading tray, thereby loading and dispensing all sizes of cigarette packs, rather than only cigarette packs having the same size, compared to a conventional vending machine storing cigarette packs having the same size.

### TECHNICAL FIELD

The present invention relates to a kiosk-integrated cigarette vending machine, and more particularly to a kiosk-integrated cigarette vending machine, which employs an internal loading/unloading unit having a cylindrical loading tray, thereby minimizing the size thereof and thus maximizing the efficiency of use of space compared to a conventional vending machine having a horizontal arrangement structure, which includes a reduced number of modules to be controlled, i.e. a rotary module for rotating the cylindrical loading tray and a push module for pushing a selected one of cigarette packs loaded in the cylindrical loading tray to dispense the same, thereby minimizing the probability of error occurrence and simplifying the maintenance thereof, and which includes size guides formed to be selectively mounted in slots in the cylindrical loading tray, thereby loading and dispensing all sizes of cigarette packs, rather than only cigarette packs having the same size, compared to a conventional vending machine storing cigarette packs having the same size.

### BACKGROUND ART

In general, vending machines are devices that enable unmanned sale of products.

That is, vending machines are devices that automatically dispense a product selected by a customer in response to payment for the same using coins, bills, credit cards, transportation cards, or the like.

Among these vending machines, a cigarette vending machine for sale of packs of cigarettes is generally configured such that “n” packs of cigarettes are loaded in a given space and one of first to n^{th} modules is selected and pushed.

In this case, however, “n” modules are needed to dispense products. That is, the greater the number of products, the greater the number of modules.

Therefore, there is a problem in that, as the number of modules to be controlled in a hardware manner increases, the possibility of occurrence of unexpected situations and operation errors increases.

Moreover, a conventional cigarette vending machine for dispensing packs of cigarettes is of a spring type or a rail type, and thus is not capable of checking the number of packs of cigarettes that can be currently dispensed or the total number of remaining packs of cigarettes in a hardware manner. Therefore, a manager experiences inconvenience of having to manually input the number of products.

Furthermore, about 185 types of cigarettes are available on the market, and the sizes thereof are different.

However, a conventional cigarette vending machine has problems in that cigarette packs having the same size are loaded in each line and it is difficult to load and dispense various sizes of cigarette packs due to a limited size and storage space thereof. For this reason, a manager experiences inconvenience of having to change the settings of the vending machine when cigarette packs having another size are loaded.

In addition, in the case in which packs of cigarettes are loaded in respective lines, the size of the cigarette vending machine increases, and there are many cases in which unselected packs of cigarettes are dispensed at the time of dispensing a pack of cigarettes.

Therefore, research and development have been conducted to provide a cigarette vending machine capable of minimizing the size thereof to maximize the efficiency of use of space, reducing the number of modules to be controlled to minimize the probability of error occurrence and simplify the maintenance thereof, and loading and dispensing all sizes of cigarette packs, rather than only cigarette packs having the same size, unlike a conventional vending machine.
(Patent Document 1) Korean Patent Laid-Open Publication No. 10-1999-0025751, published on Apr. 6, 1999
(Patent Document 2) Korean Utility Model Registration No. 20-0471964, registered on Mar. 19, 2014
(Patent Document 3) Korean Patent Registration No. 10-2293283, registered on Aug. 18, 2021

### DISCLOSURE

### Technical Problem

The present invention has been made in an effort to solve the above-described problems, and it is an object of the present invention to provide a kiosk-integrated cigarette vending machine, which employs an internal loading/unloading unit having a cylindrical loading tray, thereby minimizing the size thereof and thus maximizing the efficiency of use of space compared to a conventional vending machine having a horizontal arrangement structure.

It is another object of the technology according to the present invention to provide a kiosk-integrated cigarette vending machine, which includes a reduced number of modules to be controlled, i.e. a rotary module for rotating the cylindrical loading tray and a push module for pushing a selected one of cigarette packs loaded in the cylindrical loading tray to dispense the same, thereby minimizing the probability of error occurrence and simplifying the maintenance thereof.

It is still another object of the technology according to the present invention to provide a kiosk-integrated cigarette vending machine, which includes size guides formed to be selectively mounted in slots in the cylindrical loading tray, thereby loading and dispensing all sizes of cigarette packs, rather than only cigarette packs having the same size, compared to a conventional vending machine storing cigarette packs having the same size.

### Technical Solution

The present invention for accomplishing the above objects is as follows. That is, a kiosk-integrated cigarette vending machine according to the present invention includes a cigarette dispenser configured to store a plurality of cigarette packs of various sizes therein such that the plurality of cigarette packs is loaded in a circumferential direction and to dispense one selected by a consumer from among the cigarette packs stored therein so that the consumer receives the selected cigarette pack, and a kiosk connected to the cigarette dispenser via a cable to control operation of the cigarette dispenser such that the cigarette dispenser dispenses one selected from among the cigarette packs loaded therein in response to selection and payment by the customer.

In this case, the cigarette dispenser includes a case including a main body formed in a shape of a box having an open front surface, an opening/closing door hinged at one side thereof to the open front surface of the main body to close an open side of the main body, a dispensing duct having an open upper end and extending downwards from a lower portion of a rear side of the opening/closing door, and a dispensing door hingedly mounted at an upper end thereof to a communication portion in the opening/closing door through which a lower end of the dispensing duct communicates with a region ahead of the opening/closing door, and an internal loading/unloading unit mounted in an upper portion of an interior of the main body of the case to store the plurality of cigarette packs such that the cigarette packs are loaded therein in the circumferential direction and to unload a selected cigarette pack under the control of the kiosk.

Further, the internal loading/unloading unit operates under the control of the kiosk, and preferably includes a seating base fixedly mounted in an inner space of the main body at a position above the dispensing door of the opening/closing door, the seating base having an ejection slit formed in one side thereof, a cylindrical loading tray formed in a shape of a cylinder having a plurality of slots formed therein in the circumferential direction to allow each of the cigarette packs to be loaded in a respective one of the slots, the cylindrical loading tray being rotatably seated on the seating base, an upper cover fixedly disposed above the cylindrical loading tray, a rotary module mounted to a center of a lower portion of the cylindrical loading tray to rotate the cylindrical loading tray, and a push module configured to push a cigarette pack loaded in a lower portion of a selected one of the slots out of the cylindrical loading tray to cause the cigarette pack to fall into the ejection slit in the state in which the selected slot is aligned with the ejection slit in the seating base by rotational operation of the rotary module.

In addition, the cigarette packs are loaded in multiple layers, including a first layer, a second layer, and a third layer defined from below to above, in each of the slots in the cylindrical loading tray, and the cylindrical loading tray preferably includes an upper shield provided outside the slots to shield spaces corresponding to the second layer and the third layer in each of the slots to allow only a cigarette pack loaded in the first layer to be unloaded by operation of the push module while preventing cigarette packs loaded in the second layer and the third layer from being unloaded, and a lower shield provided outside the slots to shield a space corresponding to the first layer in each of the slots, the lower shield having a guide hole formed therein in the circumferential direction to allow one of the slots to communicate with the outside therethrough, whereby, when the cigarette pack loaded in the first layer in the one slot is unloaded, cigarette packs loaded in first layers in neighboring slots are prevented from being unloaded.

Further, the cylindrical loading tray preferably further includes storage detection sensors, three of the storage detection sensors being mounted corresponding to the first layer, the second layer, and the third layer defined from below to above in each of the slots in order to detect a loaded state of a cigarette pack in any one of the first layer, the second layer, and the third layer in each of the slots.

In addition, the cylindrical loading tray preferably includes a size guide removably inserted into each of the slots from above in order to selectively reduce a width of an inner space of each of the slots, whereby the cylindrical loading tray stores cigarette packs having various sizes, rather than cigarette packs having an identical size, in the plurality of slots formed in the circumferential direction.

In addition, the cylindrical loading tray preferably includes a plurality of groups of slot position identification protrusions protruding from a lower surface of the cylindrical loading tray, the groups of slot position identification protrusions being respectively formed at positions corresponding to the plurality of slots in the circumferential direction, the groups of slot position identification protrusions including different numbers of protrusions so that the slots are recognized and distinguished from each other based on a hexadecimal number system, and the seating base, on which the cylindrical loading tray is seated, preferably includes a slot position detection sensor provided on an upper surface thereof to sense the groups of slot position identification protrusions and thus to detect ordinal numbers of the slots in the circumferential direction, whereby, when the cylindrical loading tray is rotated by the rotary module and a selected one of the slots is located so as to be aligned with the ejection slit in the seating base, an ordinal number of the selected slot in the circumferential direction is detected.

In addition, the kiosk is configured to have a touchscreen function and a card-reading function and to communicate with an Internet network, and is integrated with the cigarette dispenser in a manner of being in close contact with one side of the cigarette dispenser and connected to the cigarette dispenser via a cable, whereby the kiosk controls operation of the cigarette dispenser to dispense one selected from among the cigarette packs loaded in the cigarette dispenser in response to selection and payment by the customer.

### Advantageous Effects

Effects of the kiosk-integrated cigarette vending machine according to the present invention are as follows.

First, since the internal loading/unloading unit having the cylindrical loading tray is employed, it is possible to minimize the size of the vending machine and thus to maximize the efficiency of use of space compared to a conventional vending machine having a horizontal arrangement structure.

Second, since only the rotary module for rotating the cylindrical loading tray and the push module for pushing a selected one of the cigarette packs loaded in the cylindrical loading tray to dispense the same are controlled, it is possible to minimize the probability of error occurrence and to simplify the maintenance of the vending machine by virtue of reduction in the number of modules to be controlled.

Third, since the size guides are selectively mounted in the slots in the cylindrical loading tray, it is possible to load all sizes of cigarette packs, rather than only cigarette packs having the same size, in a single vending machine and to dispense the same compared to a conventional vending machine storing cigarette packs having the same size.

### DESCRIPTION OF DRAWINGS

FIG. 1 is a perspective view showing the external structure of a kiosk-integrated cigarette vending machine according to the present invention.

FIG. 2 is a perspective view showing the overall configuration of the kiosk-integrated cigarette vending machine according to the present invention and the internal structure of a cigarette dispenser thereof.

FIG. 3 is a front view showing the configuration of the kiosk-integrated cigarette vending machine according to the present invention.

FIGS. 4A to 4C are views showing a structure in which cigarette packs are classified according to sizes and cigarette packs having the same size are stored in three layers in an internal loading/unloading unit, which is a main part of the kiosk-integrated cigarette vending machine according to the present invention.

FIG. 5 is a perspective view showing a structure in which a cigarette pack is unloaded from the internal loading/unloading unit, which is a main part of the kiosk-integrated cigarette vending machine according to the present invention.

FIG. 6 is a perspective view showing the internal loading/unloading unit, which is a main part of the kiosk-integrated cigarette vending machine according to the present invention.

FIG. 7 is a front view of FIG. 6.

FIGS. 8A and 8B are views showing a detailed storage structure of the internal loading/unloading unit for storing cigarette packs according to sizes in the kiosk-integrated cigarette vending machine according to the present invention.

FIG. 9 is a bottom view showing the structure of a bottom of a cylindrical loading tray of the internal loading/unloading unit, which is a main part of the kiosk-integrated cigarette vending machine according to the present invention.

### BEST MODE

Hereinafter, preferred embodiments of a kiosk-integrated cigarette vending machine according to the present invention will be described in detail with reference to the accompanying drawings.

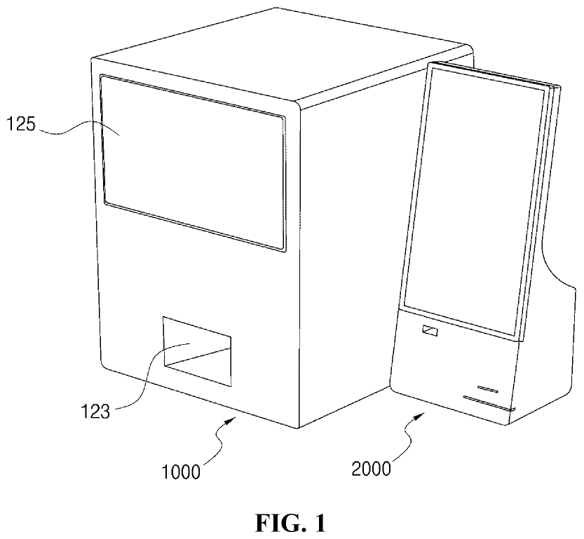

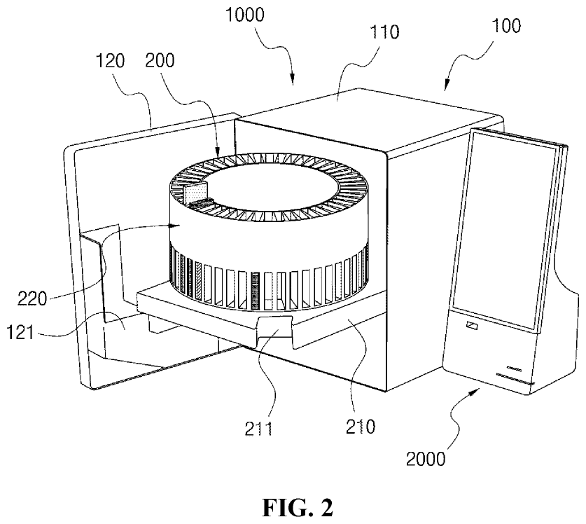

FIG. 1 is a perspective view showing the external structure of a kiosk-integrated cigarette vending machine according to the present invention, and FIG. 2 is a perspective view showing the overall configuration of the kiosk-integrated cigarette vending machine according to the present invention and the internal structure of a cigarette dispenser thereof.

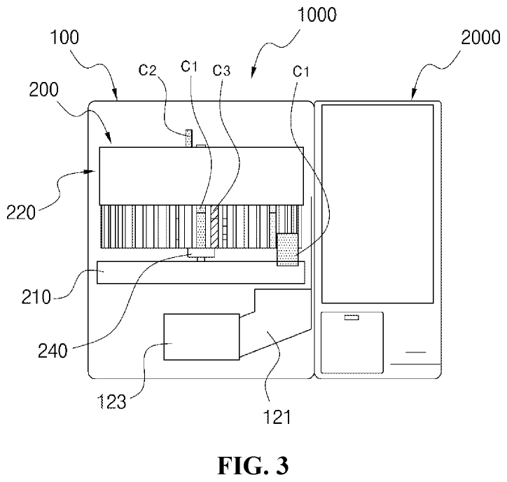

FIG. 3 is a front view showing the configuration of the kiosk-integrated cigarette vending machine according to the present invention.

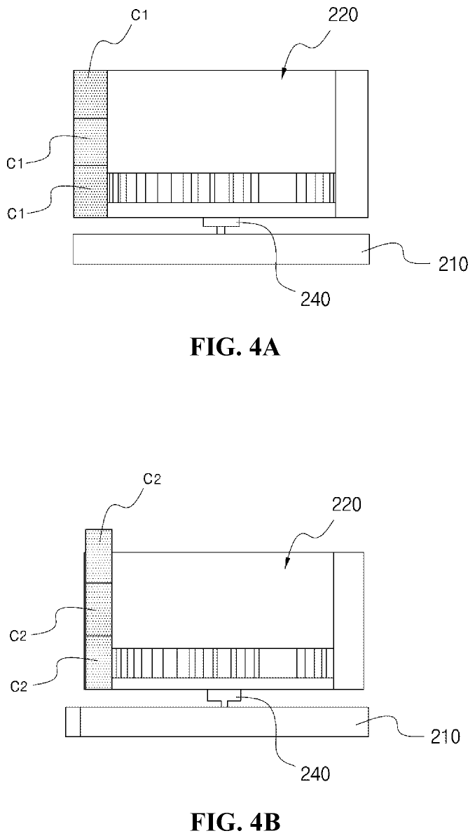

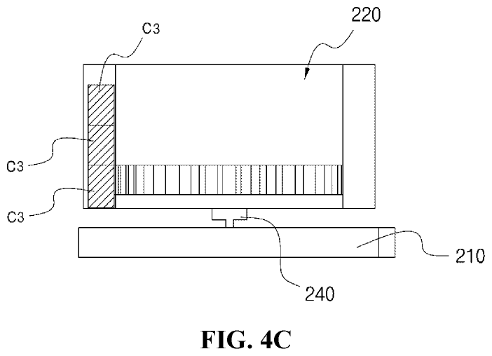

FIGS. 4A to 4C are views showing a structure in which cigarette packs are classified according to sizes and cigarette packs having the same size are stored in three layers in an internal loading/unloading unit, which is a main part of the kiosk-integrated cigarette vending machine according to the present invention.

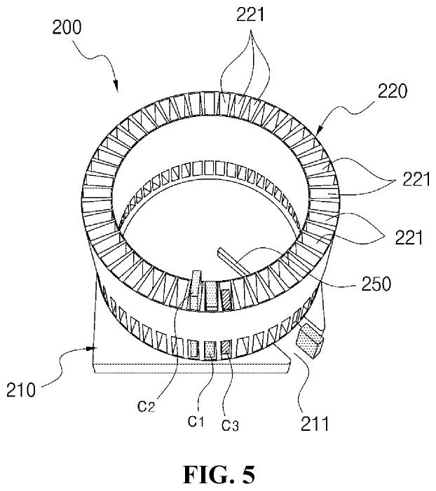

FIG. 5 is a perspective view showing a structure in which a cigarette pack is unloaded from the internal loading/unloading unit, which is a main part of the kiosk-integrated cigarette vending machine according to the present invention.

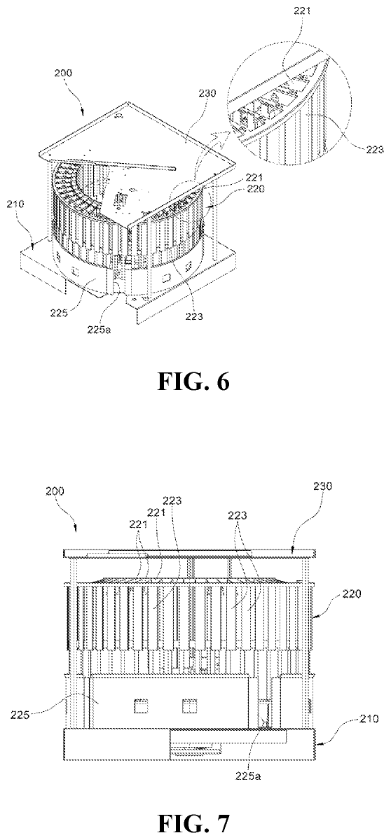

FIG. 6 is a perspective view showing the internal loading/unloading unit, which is a main part of the kiosk-integrated cigarette vending machine according to the present invention, and FIG. 7 is a front view of FIG. 6.

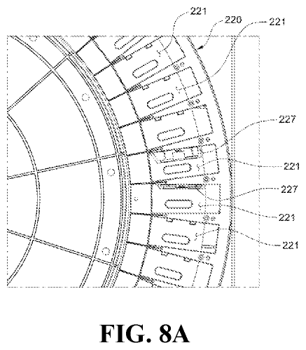

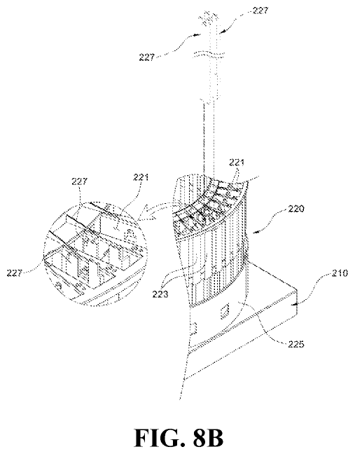

FIGS. 8A and 8B are views showing a detailed storage structure of the internal loading/unloading unit for storing cigarette packs according to sizes in the kiosk-integrated cigarette vending machine according to the present invention.

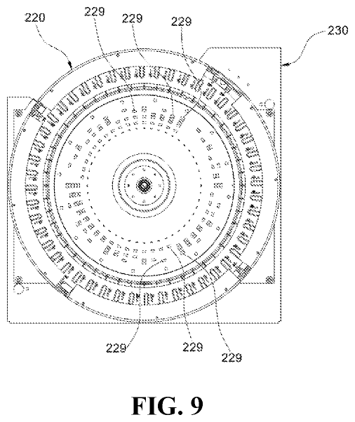

FIG. 9 is a bottom view showing the structure of a bottom of a cylindrical loading tray of the internal loading/unloading unit, which is a main part of the kiosk-integrated cigarette vending machine according to the present invention.

As shown in FIGS. 1 to 9, a kiosk-integrated cigarette vending machine according to a preferred embodiment of the present invention mainly includes a cigarette dispenser 1000 and a kiosk 2000.

In this case, the cigarette dispenser 1000 stores a plurality of cigarette packs C1, C2, and C3 having various sizes therein such that the cigarette packs are loaded in a circumferential direction, and dispenses one selected by a consumer from among the cigarette packs C1, C2, and C3 stored therein so that the consumer can receive the same.

In addition, the kiosk 2000 is connected to the cigarette dispenser 1000 via a cable to control operation of the cigarette dispenser 1000 such that the cigarette dispenser 1000 dispenses one selected from among the cigarette packs C1, C2, and C3 loaded therein in response to selection and payment by the customer.

In particular, it is important to construct the kiosk 2000 so that the kiosk 2000 is capable of controlling operation of the cigarette dispenser 1000 to dispense one selected from among the cigarette packs C1, C2, and C3 loaded in the cigarette dispenser 1000 in response to selection and payment by the customer.

To this end, preferably, the kiosk 2000 is constructed to have a touchscreen function and a card-reading function and to communicate with an Internet network, and is integrated with the cigarette dispenser 1000 in a manner of being in close contact with one side of the cigarette dispenser 1000 and connected to the cigarette dispenser 1000 via a cable.

Meanwhile, the cigarette dispenser 1000, which is a main part of the present invention, includes a case 100 and an internal loading/unloading unit 200.

In detail, the case 100 is configured such that a main body 110 is formed in a shape of a box having an open front surface, an opening/closing door 120 is hinged at one side thereof to the open front surface of the main body 110 to close the open side of the main body 110, a dispensing duct 121 having an open upper end extends downwards from a lower portion of a rear side of the opening/closing door 120, and a dispensing door 123 is hingedly mounted at an upper end thereof to a communication portion in the opening/closing door 120, through which a lower end of the dispensing duct 121 communicates with a region ahead of the opening/closing door 120.

In this case, preferably, a digital information display 125 is additionally provided on an upper portion of a front surface of the opening/closing door 120. The digital information display 125 is a “digital information display” that functions as a general monitor.

In addition, the internal loading/unloading unit 200 is mounted in an upper portion of the interior of the main body 110 of the case 100 to store the plurality of cigarette packs C1, C2, and C3 such that the cigarette packs are loaded therein in the circumferential direction and to unload a selected cigarette pack under the control of the kiosk 2000.

This internal loading/unloading unit 200 operates under the control of the kiosk 2000, and mainly includes a seating base 210, a cylindrical loading tray 220, an upper cover 230, a rotary module 240, and a push module 250.

In detail, the seating base 210 is fixedly mounted in an inner space of the main body 110 at a position above the dispensing door 123 of the opening/closing door 120, and has an ejection slit 211 formed in one side thereof.

In addition, the cylindrical loading tray 220 is formed in a shape of a cylinder having a plurality of slots 221 formed therein in the circumferential direction to allow each of the cigarette packs C1, C2, and C3 to be loaded in a respective one of the slots 221, and is rotatably seated on the seating base 210.

In addition, the upper cover 230 is fixedly disposed above the cylindrical loading tray 220.

In particular, it is more preferable for the upper cover 230 to have a fan-shaped opening formed in one side of an upper portion thereof so that the cigarette packs are loaded in the slots 221 in the cylindrical loading tray 220 through the opening from above.

Meanwhile, the rotary module 240 is mounted to a center of a lower portion of the cylindrical loading tray 220 to rotate the cylindrical loading tray 220.

This rotary module 240 is preferably implemented as, for example, a driving motor, which is provided on a center of an upper surface of the seating base 210 such that the cylindrical loading tray 220 is connected at a center of a lower surface thereof to a motor shaft extending upwards so as to be rotated by the driving motor.

In addition, the push module 250 pushes the cigarette pack C1 loaded in a lower portion of a selected one of the slots 221 out of the cylindrical loading tray 220 to cause the cigarette pack C1 to fall into the ejection slit 211 in the state in which the selected slot 221 is aligned with the ejection slit 211 in the seating base 210 by rotational operation of the rotary module 240.

In particular, this push module 250 is preferably implemented as a step motor linear actuator.

Meanwhile, in the internal loading/unloading unit 200 configured as described above, the cigarette packs C1, C2, and C3 are loaded in multiple layers, including a first layer, a second layer, and a third layer defined from below to above, in each of the slots 221 in the cylindrical loading tray 220.

The cylindrical loading tray 220 includes an upper shield 223 provided outside the slots 221 to shield spaces corresponding to the second layer and the third layer in each of the slots 221, thereby allowing only the cigarette pack C1 loaded in the first layer to be unloaded by operation of the push module 250 while preventing the cigarette packs C2 and C3 loaded in the second layer and the third layer from being unloaded.

In addition, preferably, the cylindrical loading tray 220 includes a lower shield 225 provided outside the slots 221 to shield a space corresponding to the first layer in each of the slots 221, and the lower shield 225 has a guide hole 225a formed therein in the circumferential direction to allow one of the slots 221 to communicate with the outside therethrough, whereby, when the cigarette pack C1 loaded in the first layer in the one slot 221 is unloaded, the cigarette packs C1 loaded in the first layers in neighboring slots 221 are prevented from being unloaded.

In addition, more preferably, the cylindrical loading tray 220 further includes storage detection sensors (not shown), three of which are mounted corresponding to the first layer, the second layer, and the third layer defined from below to above in each of the slots 221 in order to detect a loaded state of the cigarette pack in any one of the first layer, the second layer, and the third layer in each of the slots 221.

In other words, although not specifically shown in the drawings, it is preferable to mount three storage detection sensors (not shown) for each of the slots 221 in such a manner that the three storage detection sensors are spaced apart from each other at a regular interval from below to above.

Furthermore, it is also important that the cylindrical loading tray 220 be capable of storing cigarette packs C1, C2, and C3 having various sizes, rather than cigarette packs having the same size, in the plurality of slots 221 formed in the circumferential direction.

To this end, the cylindrical loading tray 220 includes a size guide 227, which is removably inserted into each of the slots 221 from above in order to selectively reduce the width of an inner space of each of the slots 221.

In this case, it is important that the size guide 227 be formed to allow three types of cigarette packs C1, C2, and C3 having various sizes, i.e. a normal-type cigarette pack, a slim-type cigarette pack, and a cigarette pack for an electronic cigarette, to be selectively loaded in the slots 221.

To this end, preferably, each of the slots 221 is formed to be suitable for a width of a normal-type cigarette pack, and two types of size guides 227 having different widths, i.e. a size guide 227 for storing a slim-type cigarette pack and a size guide 227 for storing a cigarette pack for an electronic cigarette, are provided in the slots 221.

In the present invention described above, each of the cigarette packs C1, C2, and C3 means a container that usually contains a plurality of cigarettes in a sealed manner, i.e. a pack of cigarettes.

The above-described three types of cigarette packs C1, C2, and C3, i.e. a normal-type cigarette pack, a slim-type cigarette pack, and a cigarette pack for an electronic cigarette, encompass all sizes of cigarette packs available on the market.

As described above, the present invention employs two or more types of size guides 227 having different widths in order to store and dispense the above-described three types of cigarette packs C1, C2, and C3. However, the present invention may also be used to store products other than the cigarette packs C1, C2, and C3, which have various sizes, i.e. widths and lengths similar to those of the various types of cigarette packs, and to dispense the products in response to operation of the kiosk 2000.

That is, the present invention is not limited to storage and dispensing of cigarette packs C1, C2, and C3 having various widths and lengths, but may also be used to store and dispense other products having shapes similar to various types of cigarette packs.

In other words, in the present invention, although not specifically shown in the drawings, various sizes of cigarette packs C1, C2, and C3 stored in the cigarette dispenser 1000 may be substituted with box-type products that contain articles other than cigarettes in cigarette-pack-shaped boxes having various widths and lengths.

In the case of the above-described box-type products that are stored in the cigarette dispenser 1000 and contain articles other than cigarettes in cigarette-pack-shaped boxes, the articles packed in the boxes may be any of various articles such as, for example, playing cards and bars of soap.

Meanwhile, when the above-described cylindrical loading tray 220 is rotated by the rotary module 240 and a selected one of the slots 221 is located so as to be aligned with the ejection slit 211 in the seating base 210, it is also important to determine the ordinal number of the selected slot 221 in the circumferential direction.

To this end, the cylindrical loading tray 220 includes a plurality of groups of slot position identification protrusions 229 protruding from a lower surface of the cylindrical loading tray 220. The groups of slot position identification protrusions 229 are respectively formed at positions corresponding to the plurality of slots 221 in the circumferential direction, and include different numbers of protrusions so that the slots 221 are recognized and distinguished from each other based on a hexadecimal number system.

In addition, preferably, the seating base, on which the cylindrical loading tray 220 is seated, includes a slot position detection sensor provided on an upper surface thereof to sense the groups of slot position identification protrusions 229 and thus to detect the ordinal numbers of the slots 221 in the circumferential direction.

The operation process of the kiosk-integrated cigarette vending machine according to the present invention configured as described above will now be described in brief. First, a customer selects his/her desired cigarette pack and pays for the same using the kiosk 2000.

Subsequently, the cylindrical loading tray 220 is rotated by the rotary module 240 so that a slot 221 in which the selected cigarette pack is loaded reaches a position corresponding to the ejection slit 211 in the seating base 210. Subsequently, the selected cigarette pack is pushed by the push module 250, falls into the dispensing duct 121 through the ejection slit 211, and is finally dispensed to the communication portion in the opening/closing door 120, which is shielded by the dispensing door 123, via the dispensing duct 121.

The customer takes the cigarette pack completely dispensed through the above process out of the vending machine, thereby completing purchase of the cigarette pack.

According to the kiosk-integrated cigarette vending machine of the present invention configured as described above, since the internal loading/unloading unit having the cylindrical loading tray is employed, it is possible to minimize the size of the vending machine and thus to maximize the efficiency of use of space compared to a conventional vending machine having a horizontal arrangement structure.

In addition, since only the rotary module for rotating the cylindrical loading tray and the push module for pushing a selected one of the cigarette packs loaded in the cylindrical loading tray to dispense the same are controlled, it is possible to minimize the probability of error occurrence and to simplify the maintenance of the vending machine by virtue of reduction in the number of modules to be controlled.

Furthermore, since the size guides are selectively mounted in the slots in the cylindrical loading tray, it is possible to load all sizes of cigarette packs, rather than only cigarette packs having the same size, in a single vending machine and to dispense the same compared to a conventional vending machine storing cigarette packs having the same size.

Although the specific preferred embodiments of the present invention have been illustrated and described above, the present invention is not limited to the embodiments, and various changes and modifications may be made by those skilled in the art without departing from the spirit of the present invention.

### DESCRIPTION OF REFERENCE SYMBOLS

1000: cigarette dispenser
100: case
110: main body
120: opening/closing door
121: dispensing duct
123: dispensing door
125: digital information display
200: internal loading/unloading unit
210: seating base
211: ejection slit
220: cylindrical loading tray
221: slot
223: upper shield
225: lower shield
225a: guide hole
227: size guide
229: slot position identification protrusion
230: upper cover
240: rotary module
250: push module
2000: kiosk
C1, C2, C3: cigarette pack

1. A kiosk-integrated cigarette vending machine comprising:
a cigarette dispenser (1000) configured to store a plurality of cigarette packs (C1, C2, and C3) of various sizes therein such that the plurality of cigarette packs is loaded in a circumferential direction and to dispense one selected by a consumer from among the cigarette packs (C1, C2, and C3) stored therein so that the consumer receives the selected cigarette pack; and
a kiosk (2000) connected to the cigarette dispenser (1000) via a cable to control operation of the cigarette dispenser (1000) such that the cigarette dispenser (1000) dispenses one selected from among the cigarette packs (C1, C2, and C3) loaded therein in response to selection and payment by the customer.

2. The kiosk-integrated cigarette vending machine according to claim 1, wherein the cigarette dispenser (1000) comprises:
a case (100) comprising a main body (110) formed in a shape of a box having an open front surface, an opening/closing door (120) hinged at one side thereof to the open front surface of the main body (110) to close an open side of the main body (110), a dispensing duct (121) having an open upper end and extending downwards from a lower portion of a rear side of the opening/closing door (120), and a dispensing door (123) hingedly mounted at an upper end thereof to a communication portion in the opening/closing door (120) through which a lower end of the dispensing duct (121) communicates with a region ahead of the opening/closing door (120); and
an internal loading/unloading unit (200) mounted in an upper portion of an interior of the main body (110) of the case (100) to store the plurality of cigarette packs (C1, C2, and C3) such that the cigarette packs are loaded therein in the circumferential direction and to unload a selected cigarette pack under control of the kiosk (2000).

3. The kiosk-integrated cigarette vending machine according to claim 2, wherein the internal loading/unloading unit (200) operates under control of the kiosk (2000), the internal loading/unloading unit (200) comprising:
a seating base (210) fixedly mounted in an inner space of the main body (110) at a position above the dispensing door (123) of the opening/closing door (120), the seating base (210) having an ejection slit (211) formed in one side thereof;
a cylindrical loading tray (220) formed in a shape of a cylinder having a plurality of slots (221) formed therein in the circumferential direction to allow each of the cigarette packs (C1, C2, and C3) to be loaded in a respective one of the slots (221), the cylindrical loading tray (220) being rotatably seated on the seating base (210);
an upper cover (230) fixedly disposed above the cylindrical loading tray (220);
a rotary module (240) mounted to a center of a lower portion of the cylindrical loading tray (220) to rotate the cylindrical loading tray (220); and
a push module (250) configured to push a cigarette pack (C1) loaded in a lower portion of a selected one of the slots (221) out of the cylindrical loading tray (220) to cause the cigarette pack (C1) to fall into the ejection slit (211) in a state in which the selected slot (221) is aligned with the ejection slit (211) in the seating base (210) by rotational operation of the rotary module (240).

4. The kiosk-integrated cigarette vending machine according to claim 3, wherein the cigarette packs (C1, C2, and C3) are loaded in multiple layers, comprising a first layer, a second layer, and a third layer defined from below to above, in each of the slots (221) in the cylindrical loading tray (220), and
wherein the cylindrical loading tray (220) comprises:
an upper shield (223) provided outside the slots (221) to shield spaces corresponding to the second layer and the third layer in each of the slots (221) to allow only a cigarette pack (C1) loaded in the first layer to be unloaded by operation of the push module (250) while preventing cigarette packs (C2 and C3) loaded in the second layer and the third layer from being unloaded; and
a lower shield (225) provided outside the slots (221) to shield a space corresponding to the first layer in each of the slots (221), the lower shield (225) having a guide hole (225a) formed therein in the circumferential direction to allow one of the slots (221) to communicate with an outside therethrough, whereby, when the cigarette pack (C1) loaded in the first layer in the one slot (221) is unloaded, cigarette packs (C1) loaded in first layers in neighboring slots (221) are prevented from being unloaded.

5. The kiosk-integrated cigarette vending machine according to claim 4, wherein the cylindrical loading tray (220) further comprises storage detection sensors, three of the storage detection sensors being mounted corresponding to the first layer, the second layer, and the third layer defined from below to above in each of the slots (221) in order to detect a loaded state of a cigarette pack in any one of the first layer, the second layer, and the third layer in each of the slots (221).

6. The kiosk-integrated cigarette vending machine according to claim 3, wherein the cylindrical loading tray (220) comprises a size guide (227) removably inserted into each of the slots (221) from above in order to selectively reduce a width of an inner space of each of the slots (221), whereby the cylindrical loading tray (220) stores cigarette packs (C1, C2, and C3) having various sizes, rather than cigarette packs having an identical size, in the plurality of slots (221) formed in the circumferential direction.

7. The kiosk-integrated cigarette vending machine according to claim 3, wherein the cylindrical loading tray (220) comprises a plurality of groups of slot position identification protrusions (229) protruding from a lower surface of the cylindrical loading tray (220), the groups of slot position identification protrusions (229) being respectively formed at positions corresponding to the plurality of slots (221) in the circumferential direction, the groups of slot position identification protrusions (229) comprising different numbers of protrusions so that the slots (221) are recognized and distinguished from each other based on a hexadecimal number system, and
wherein the seating base, on which the cylindrical loading tray (220) is seated, comprises a slot position detection sensor provided on an upper surface thereof to sense the groups of slot position identification protrusions (229) and thus to detect ordinal numbers of the slots (221) in the circumferential direction, whereby, when the cylindrical loading tray (220) is rotated by the rotary module (240) and a selected one of the slots (221) is located so as to be aligned with the ejection slit (211) in the seating base (210), an ordinal number of the selected slot (221) in the circumferential direction is detected.

8. The kiosk-integrated cigarette vending machine according to claim 3, wherein the kiosk (2000) is configured to have a touchscreen function and a card-reading function and to communicate with an Internet network, and is integrated with the cigarette dispenser (1000) in a manner of being in close contact with one side of the cigarette dispenser (1000) and connected to the cigarette dispenser (1000) via a cable, whereby the kiosk (2000) controls operation of the cigarette dispenser (1000) to dispense one selected from among the cigarette packs (C1, C2, and C3) loaded in the cigarette dispenser (1000) in response to selection and payment by the customer.

9. The kiosk-integrated cigarette vending machine according to claim 1, wherein the various sizes of cigarette packs (C1, C2, and C3) stored in the cigarette dispenser (1000) are substituted with box-type products containing articles other than cigarettes in cigarette-pack-shaped boxes having various widths and lengths.
